(19) United States
(12) Patent Application Publication
(10) Pub. No.: US 2026/0180962 A1
(43) Pub. Date: Jun. 25, 2026

(54) ELIMINATING REDUNDANT ENCRYPTION IN A DISTRIBUTED FILE SYSTEM

(71) Applicant: INTERNATIONAL BUSINESS MACHINES CORPORATION, ARMONK, NY (US)

(72) Inventors: FELIPE KNOP, POUGHKEEPSIE, NY (US); PIDAD GASFAR D'SOUZA, BENGALURU (IN); SERBAN C MAEREAN, RIDGEFIELD, CT (US); ASMAHAN ALI, POUGHKEEPSIE, NY (US)

(21) Appl. No.: 19/000,013

(22) Filed: Dec. 23, 2024

(51) Int. Cl. H04L 9/40; G06F 21/60; G06F 21/64

(52) U.S. Cl. CPC H04L 63/0435; G06F 21/602; G06F 21/64; H04L 63/166

(57) ABSTRACT

Eliminating redundant encryption in a distributed file system, including: encrypting, by a first node of a distributed file system, data to be stored in a storage device of the distributed file system; sending, by the first node to a second node of the distributed file system, the encrypted data using an unsecured network connection; sending, by the first node and to the second node of the distributed file system, integrity information for the encrypted data using an authenticated encrypted network connection; and storing, by the second node, the encrypted data into the storage device.

### BACKGROUND

The present disclosure relates to methods, apparatus, and products for eliminating redundant encryption in a distributed file system.

### SUMMARY

According to embodiments of the present disclosure, various methods, systems and products for eliminating redundant encryption in a distributed file system are described herein. In some aspects, eliminating redundant encryption in a distributed file system includes encrypting, by a first node a distributed file system, data to be stored in a storage device of the distributed file system; sending, by the first node to a second node of the distributed file system, the encrypted data using an unsecured network connection; sending, by the first node and to the second node of the distributed file system, integrity information for the encrypted data using an authenticated encrypted network connection; and storing, by the second node, the encrypted data into the storage device. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a block diagram of an example computing environment for eliminating redundant encryption in a distributed file system in accordance with some embodiments of the present disclosure.

FIG. 2 sets forth a diagram of an example distributed file system in accordance with some embodiments of the present disclosure.

FIG. 3 sets forth a diagram of an example implementation of eliminating redundant encryption in a distributed file system in accordance with some embodiments of the present disclosure.

FIG. 4 sets forth a flowchart of an example method of eliminating redundant encryption in a distributed file system in accordance with some embodiments of the present disclosure.

FIG. 5 sets forth a flowchart of another example method of eliminating redundant encryption in a distributed file system in accordance with some embodiments of the present disclosure.

FIG. 6 sets forth a flowchart of another example method of eliminating redundant encryption in a distributed file system in accordance with some embodiments of the present disclosure.

FIG. 7 sets forth a flowchart of another example method of eliminating redundant encryption in a distributed file system in accordance with some embodiments of the present disclosure.

FIG. 8 sets forth a flowchart of another example method of eliminating redundant encryption in a distributed file system in accordance with some embodiments of the present disclosure.

### DETAILED DESCRIPTION

In a distributed file system, some nodes may not have direct access to a storage device for storing data. In order for these nodes to store data into a storage device they must transfer the data to another node that has direct access to the storage device. To protect confidentiality of the data during transfer the data should be transferred in an encrypted form. The data should also be stored in the storage device in an encrypted form to protect the data from being compromised in the event that the storage device is lost or stolen. Existing implementations for distributed file systems use encrypted network connections to transfer data between nodes so as to protect the data during transfer. Such implementations may also encrypt the data at the file system or at the storage device to protect the data while stored in the storage device. These implementations result in the data being encrypted twice, known as “double encryption,” with each application of encryption requiring non-trivial amounts of computational resources. Thus, additional computational resources are used to apply additional, redundant layers of encryption.

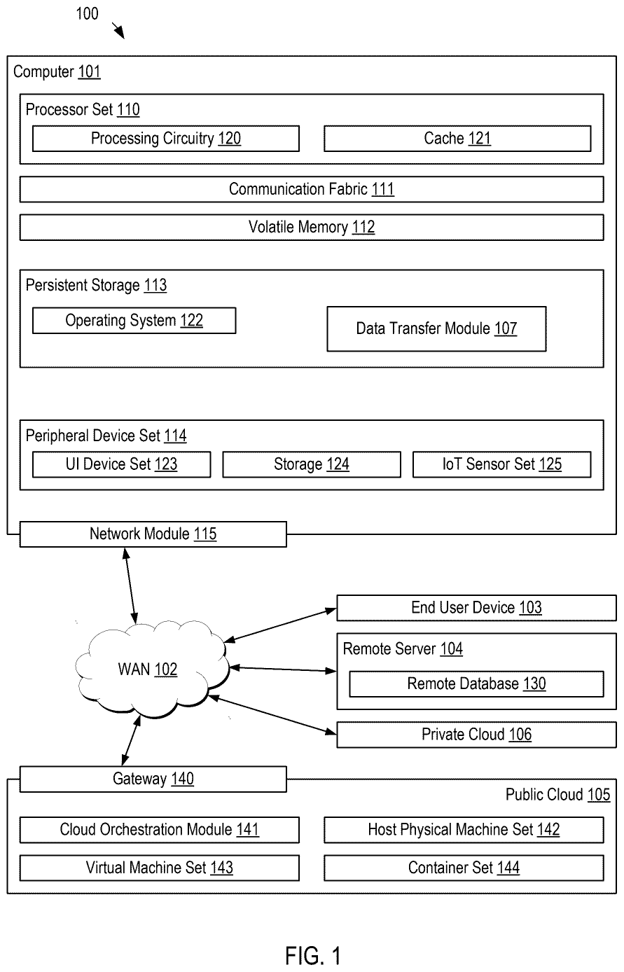

With reference now to FIG. 1, shown is an example computing environment according to aspects of the present disclosure. Computing environment 100 contains an example of an environment for the execution of at least some of the computer code involved in performing the various methods described herein, such as a data transfer module 107. In addition to the data transfer module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data transfer module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

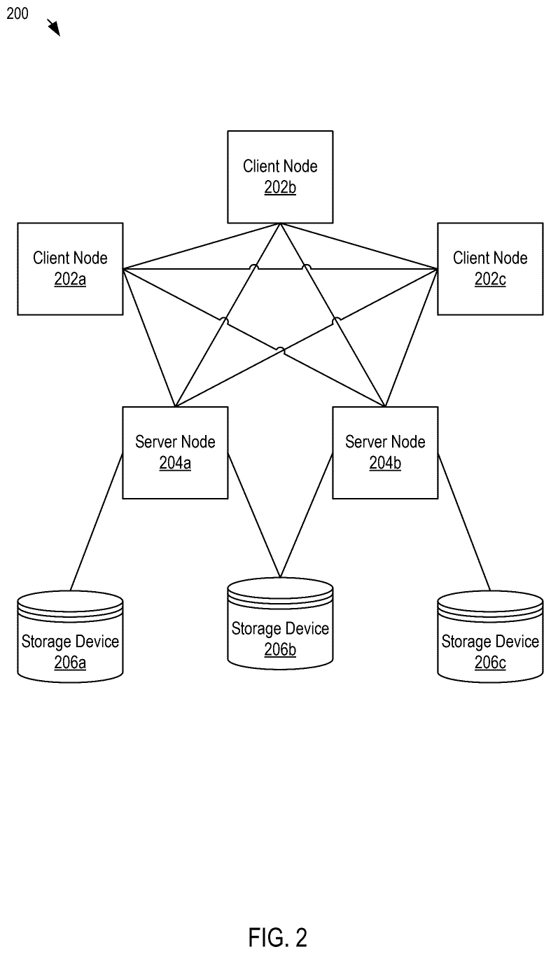

FIG. 2 sets forth a diagram of an example distributed file system 200 in accordance with some embodiments of the present disclosure. In a distributed file system 200, functionality is spread across multiple nodes communicating over a network using agents, daemons, or other processes. Here, the distributed file system 200 includes client nodes 202a, b, c and server nodes 204a,b. Client nodes 202a-c are distinguished from server nodes 204a,b in that only the server nodes 204a,b have direct access or connections to storage devices 206a, b, c. In order for a client node 202a-c to store data to or read data from a storage device 206a-c that data must pass through a server node 204a,b.

In order to ensure confidentiality of data and metadata transfers, any data transferred between nodes should be encrypted. Data should also be stored in encrypted form to protect the data in the event that the storage device is lost or compromised. In some existing implementations of distributed file systems 200, data may be transferred between client nodes 202a-c and server nodes 204a,b using an encrypted network connection such as an encrypted Transport Layer Security (TLS) connection, which runs on top of Transmission Control Protocol/Internet Protocol (TCP/IP). In some existing implementations, data may be stored in storage devices 206a-c after being encrypted at the file system level using symmetric key encryption such as Advanced Encryption Standard (AES) encryption. Accordingly, in some existing implementations, data to be stored in a storage device 206a-c may be encrypted twice: once for data transfer and once for data storage.

For example, assume that a client node 202a wishes to store data in a storage device 206a. In some existing implementations, the client node 202a may encrypt the data using AES encryption. The client node 202a then transfers this encrypted data to the server node 204a using a TLS connection that further encrypts the data during transfer. The server node 204a then stores the AES encrypted data into the storage device 206a. In some other existing implementations, the client node 202a may transfer the data to the server node 204a using a TLS connection. The server node 204a may then apply AES encryption to the data and store the encrypted data into the storage device 206a. In both of these example implementations the data is both transferred and stored in some encrypted form but is encrypted twice, resulting in additional computational resource usage in the distributed file system 200.

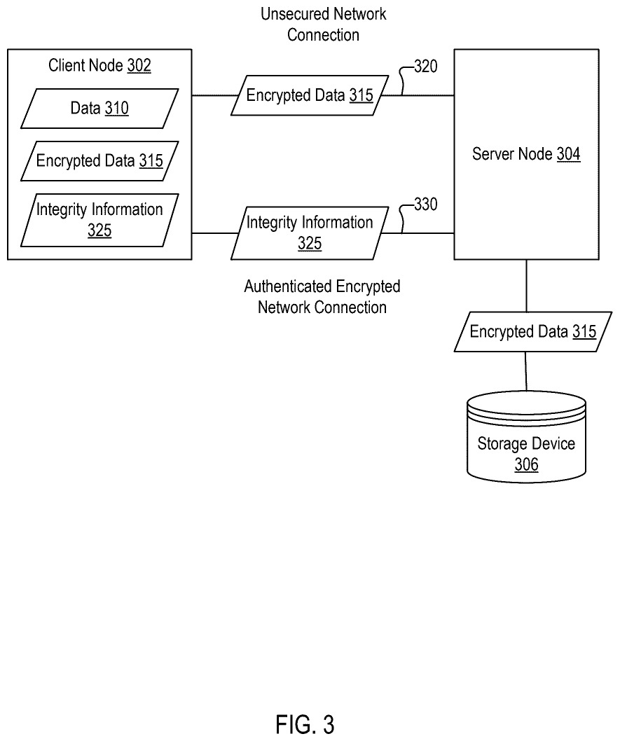

In contrast, FIG. 3 sets forth a diagram for an example implementation of eliminating redundant encryption in a distributed file system in accordance with some embodiments of the present disclosure. Here, a client node 302 is to store some data 310 into a storage device 306 via a server node 304. To do so, the client node 302 encrypts the data for storage in the storage device 306 to generate encrypted data 315 (e.g., using AES encryption or another encryption scheme as can be appreciated). The encrypted data 315 is the encrypted form in which the data 310 will ultimately be stored in the storage device 306. The client node 302 then transfers the encrypted data 315 to the server node 304 using an unsecured network connection 320. The unsecured network connection 320 is a network connection that does not apply encryption for data transfer. For example, TLS may be used to authenticate the unsecured network connection 320, but once authentication is completed, the TLS setup is dismantled and the data flows in cleartext. As the encrypted data 315 has already been encrypted prior to transfer there is no risk of the underlying data 310 being deciphered as transferred. The encrypted data 315 may then be stored in the storage device 306 by the server node 304.

In some embodiments, the encryption scheme used to generate the encrypted data 315 may not provide data integrity mechanisms to ensure that the encrypted data 315 was not corrupted or modified during transfer. Accordingly, the client node 302 may also generate integrity information 325 as a function of the encrypted data 315. The integrity information may include, for example, a checksum or another value calculated as a function of the encrypted data 315 that may be recalculated by the server node 304 so as to verify the integrity of the encrypted data 315 as received. The client node 302 may then transfer the integrity information 325 to the server node 304 using an authenticated encrypted network connection 330 such as an authenticated encrypted TLS connection.

As the integrity information 325 is much smaller than the encrypted data 315 the integrity information 325 may arrive at the server node 304 before the encrypted data 315, resulting in minimal overall impact on transmission time. Moreover, as the integrity information 325 is sent over an encrypted channel it prevents attacks such as replay attacks or man-in-the-middle attacks. The server node 304 may then verify the integrity of the encrypted data 315 by recalculating the integrity information 325 from the received encrypted data 315 and comparing that value to the integrity information 325 as received. A match of these values verifies the integrity of the encrypted data 315 as received. Accordingly, the server node 304 may store the encrypted data 315 into the storage device 306 in response to verifying the integrity of the encrypted data 315.

In the example embodiments of FIG. 3, double encryption is avoided as the data 310 is only encrypted once for storage using AES encryption. Confidentiality of the data 310 is assured by transferring the data 310 in the encrypted form that will be used for storing it in the storage device 306 (e.g., the encrypted data 315). Integrity is assured by transmitting integrity information 325 such as a checksum over an encrypted channel.

Similar approaches may be used when loading the encrypted data 315 by the client node 302 from the storage device 306. The server node 304 may load the encrypted data 315 from the storage device 306 and send the encrypted data 315 to the client node 302 via an unsecured network connection 320. The server node 304 may calculate and send integrity information 325 for the loaded encrypted data 315 via an authenticated encrypted network connection 330. The client node 302 may then verify the integrity of the encrypted data 315 as received using the integrity information 325. In response to a successful verification of integrity, the client node 302 may decrypt the encrypted data 315 to generate the data 310 (e.g., using the key that initially encrypted the data 310).

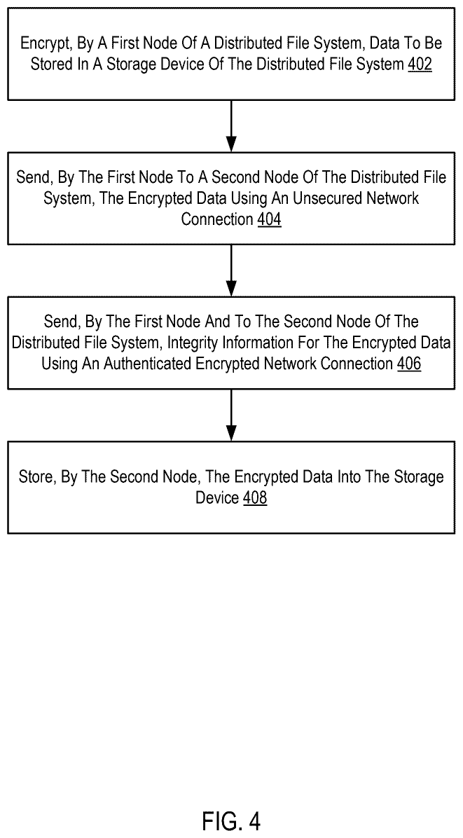

For further explanation, FIG. 4 sets forth a flowchart of an example method of eliminating redundant encryption in a distributed file system in accordance with some embodiments of the present disclosure. The method of FIG. 4 may be performed, for example, using the data transfer module 107 of FIG. 1. The method of FIG. 4 includes encrypting 402, by a first node of a distributed file system, data to be stored into a storage device of the distributed file system. The first node of the distributed file system may include, for example, a node that does not have direct access or a direct connection to the storage device (e.g., a client node). In some embodiments, encrypting 402 the data to be stored in the storage device of the distributed file system may include encrypting 402 the data using a symmetric key encryption scheme such as AES or another symmetric key encryption scheme as can be appreciated.

The method of FIG. 4 also includes sending 404, by the first node to a second node of the distributed file system, the encrypted data using an unsecured network connection. For example, TLS may be used to authenticate the unsecured network connection, but once authentication is completed, the TLS setup is dismantled and the data flows in cleartext. The second node of the distributed file system may include, for example, a node that does have direct access or a direct connection to the storage device (e.g., a server node). As the data has already been encrypted by the first node the confidentiality of the data is ensured while being transferred over an unencrypted network connection.

The method of FIG. 4 also includes sending 406, by the first node and to the second node of the distributed file system, integrity information for the encrypted data using an authenticated encrypted network connection. The integrity information is a value calculated by the first node as a function of the encrypted data (e.g., the data as encrypted by the first node) that allows the second node to verify the integrity of the encrypted data as received. For example, the integrity information may include a checksum or other value as can be appreciated. In some embodiments, the authenticated encrypted network connection includes a network connection that requires authentication to be established and applies encryption during data transfer, such as an authenticated encrypted TLS connection. As the integrity information is transferred over an encrypted network connection the confidentiality of the integrity information is ensured and attacks such as replay attacks or man-in-the-middle attacks are prevented.

The method of FIG. 4 also includes storing 408, by the second node, the encrypted data into the storage device. As the data is stored in encrypted form in the storage device the data is secured at rest in the storage device, preventing the data from being compromised in the event that the storage device itself is stolen or compromised. Readers will appreciate that the approaches set forth above provide for data to be encrypted both during data transfer and storage without applying double encryption to the data, improving overall system performance.

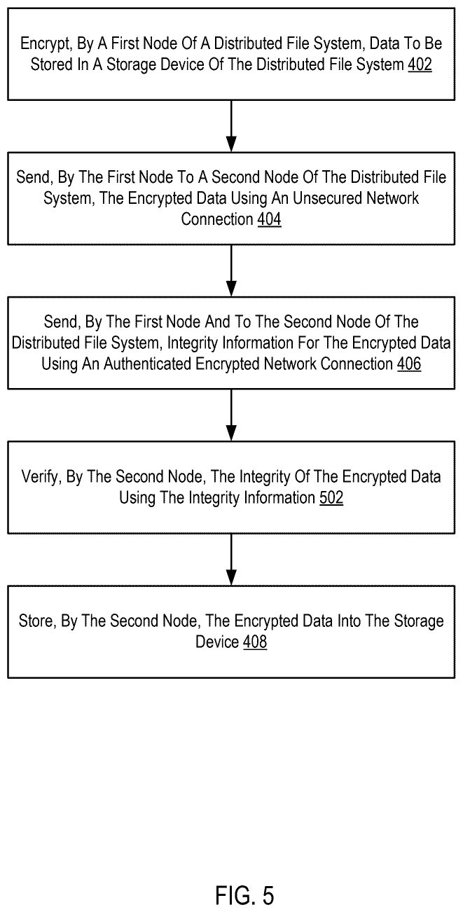

For further explanation, FIG. 5 sets forth a flowchart of another example method of eliminating redundant encryption in a distributed file system in accordance with some embodiments of the present disclosure. The method of FIG. 5 is similar to FIG. 4 in that the method of FIG. 5 also includes: encrypting 402, by a first node of a distributed file system, data to be stored into a storage device of the distributed file system; sending 404, by the first node to a second node of the distributed file system, the encrypted data using an unsecured network connection; sending 406, by the first node and to the second node of the distributed file system, integrity information for the encrypted data using an authenticated encrypted network connection; and storing 408, by the second node, the encrypted data into the storage device.

The method of FIG. 5 differs from FIG. 4 in that the method of FIG. 5 also includes: verifying 502, by the second node, the integrity of the encrypted data using the integrity information. For example, in some embodiments, the second node may calculate an expected integrity information value as a function of the encrypted data as received. The second node may then compare the expected integrity information value to the received integrity information. The integrity of the encrypted data may be verified 502 in response to a match between the expected integrity information value and the received integrity information. Accordingly, in some embodiments, storing 408, by the second node, the encrypted data into the storage device may be performed in response to successfully verifying 502 the integrity of the encrypted data.

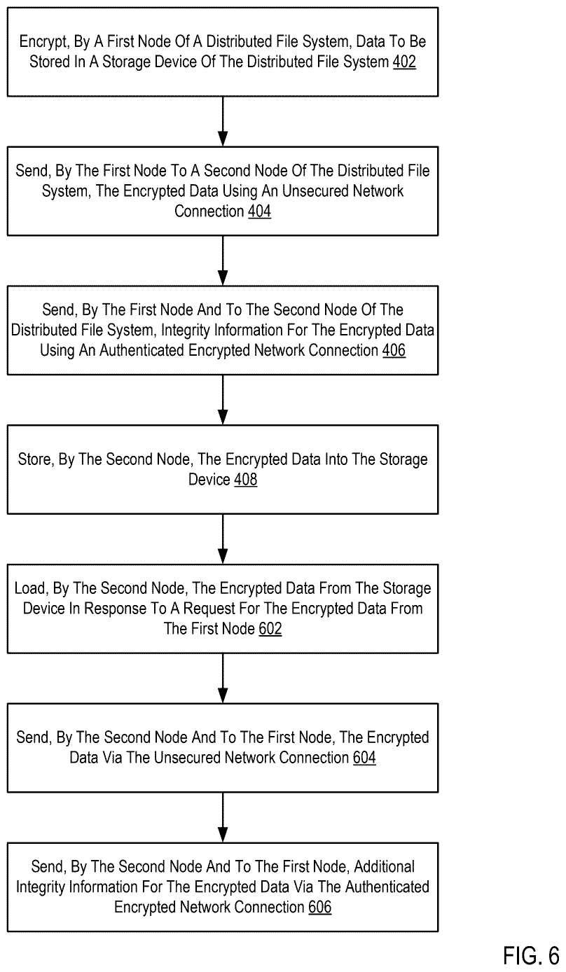

For further explanation, FIG. 6 sets forth a flowchart of another example method of eliminating redundant encryption in a distributed file system in accordance with some embodiments of the present disclosure. The method of FIG. 6 is similar to FIG. 4 in that the method of FIG. 6 also includes: encrypting 402, by a first node of a distributed file system, data to be stored into a storage device of the distributed file system; sending 404, by the first node to a second node of the distributed file system, the encrypted data using an unsecured network connection; sending 406, by the first node and to the second node of the distributed file system, integrity information for the encrypted data using an authenticated encrypted network connection; and storing 408, by the second node, the encrypted data into the storage device.

The method of FIG. 6 differs from FIG. 4 in that the method of FIG. 6 also includes loading 602, by the second node, the encrypted data from the storage device in response to a request for the encrypted data from the first node. This may include, for example, a request to read or otherwise access the data, thereby necessitating loading the encrypted data from the storage device. The method of FIG. 6 also includes sending 604, by the second node and to the first node, the encrypted data via the unsecured network connection. Sending 604, by the second node and to the first node, the encrypted data via an unsecured network connection may be performed using similar approaches as are set forth above for sending 404, by the first node to a second node of the distributed file system, the encrypted data using an unsecured network connection.

The method of FIG. 6 also includes sending 606, by the second node and to the first node, additional integrity information for the encrypted data via the authenticated encrypted network connection. The additional integrity information includes integrity information, such as a checksum, calculated by the second node as a function of the encrypted data as loaded from the storage device. Sending 606, by the second node and to the first node, additional integrity information for the encrypted data via the authenticated encrypted network connection may be performed using similar approaches as are set forth above for sending 406, by the first node and to the second node of the distributed file system, integrity information for the encrypted data using an authenticated encrypted network connection. For example, the second node may send the additional integrity information to the first node using an authenticated encrypted TLS connection. Readers will appreciate that the unsecured network connection and the authenticated encrypted network connection used by the second node to send the encrypted data and integrity information, respectively, to the first node may include the same or different network connections than those used by the first node to send the encrypted data and integrity information to the second node for storage into the storage device.

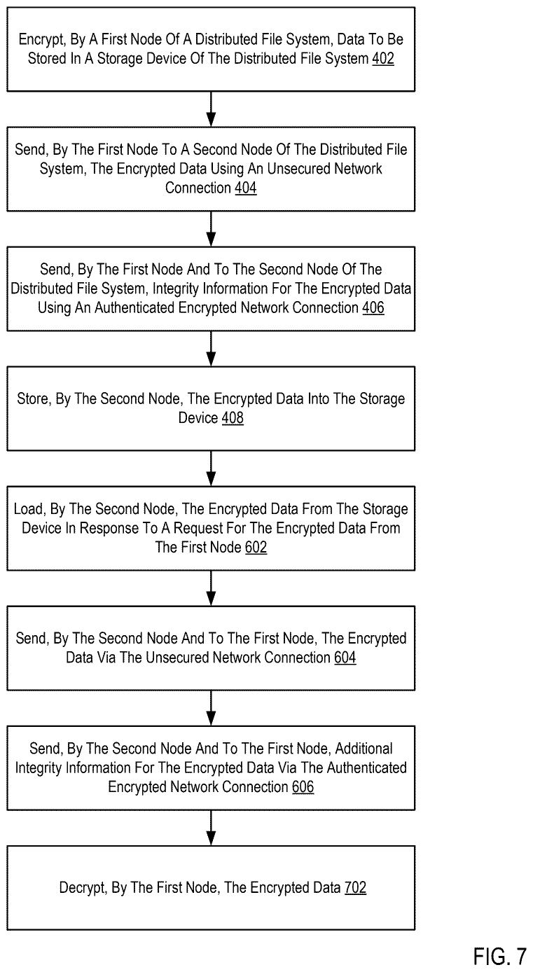

For further explanation, FIG. 7 sets forth a flowchart of another example method of eliminating redundant encryption in a distributed file system in accordance with some embodiments of the present disclosure. The method of FIG. 7 is similar to FIG. 6 in that the method of FIG. 7 also includes: encrypting 402, by a first node of a distributed file system, data to be stored into a storage device of the distributed file system; sending 404, by the first node to a second node of the distributed file system, the encrypted data using an unsecured network connection; sending 406, by the first node and to the second node of the distributed file system, integrity information for the encrypted data using an authenticated encrypted network connection; storing 408, by the second node, the encrypted data into the storage device; loading 602, by the second node, the encrypted data from the storage device in response to a request for the encrypted data from the first node; sending 604, by the second node and to the first node, the encrypted data via the unsecured network connection; and sending 606, by the second node and to the first node, additional integrity information for the encrypted data via the authenticated encrypted network connection.

The method of FIG. 7 differs from FIG. 6 in that the method of FIG. 7 also includes decrypting 702, by the first node, the encrypted data. The particular approaches for decrypting 702 the encrypted data may depend on the particular encryption approaches used by the first node in generating the encrypted data. For example, where the first node generated the encrypted data using symmetric encryption, decrypting 702 the encrypted data may include decrypting the encrypted data using the encryption key used to generate the encrypted data.

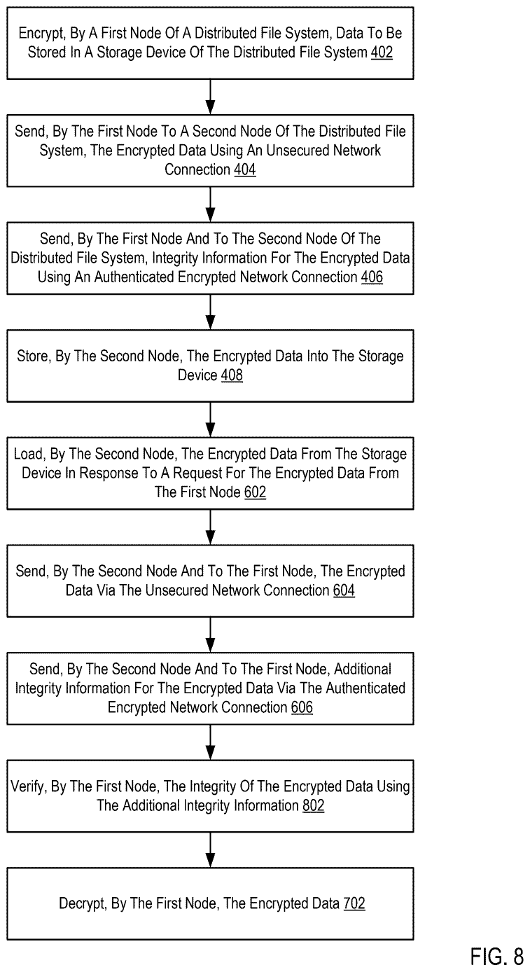

For further explanation, FIG. 8 sets forth a flowchart of another example method of eliminating redundant encryption in a distributed file system in accordance with some embodiments of the present disclosure. The method of FIG. 8 is similar to FIG. 7 in that the method of FIG. 8 also includes: encrypting 402, by a first node of a distributed file system, data to be stored into a storage device of the distributed file system; sending 404, by the first node to a second node of the distributed file system, the encrypted data using an unsecured network connection; sending 406, by the first node and to the second node of the distributed file system, integrity information for the encrypted data using an authenticated encrypted network connection; storing 408, by the second node, the encrypted data into the storage device; loading 602, by the second node, the encrypted data from the storage device in response to a request for the encrypted data from the first node; sending 604, by the second node and to the first node, the encrypted data via the unsecured network connection; sending 606, by the second node and to the first node, additional integrity information for the encrypted data via the authenticated encrypted network connection; and decrypting 702, by the first node, the encrypted data.

The method of FIG. 8 differs from FIG. 7 in that the method of FIG. 8 also includes verifying 802, by the first node, the integrity of the encrypted data using the additional integrity information. For example, in some embodiments, the first node may calculate an expected integrity information value as a function of the encrypted data as received from the second node. The first node may then compare the expected integrity information value to the received additional integrity information. The integrity of the encrypted data may be verified 802 in response to a match between the expected integrity information value and the received additional integrity information. Accordingly, in some embodiments, decrypting 702, by the first node, the encrypted data may be performed in response to the first node successfully verifying 802 the integrity of the encrypted data as received from the second node.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
encrypting, by a first node of a distributed file system, data to be stored in a storage device of the distributed file system;
sending, by the first node to a second node of the distributed file system, the encrypted data using an unsecured network connection;
sending, by the first node and to the second node of the distributed file system, integrity information for the encrypted data using an authenticated encrypted network connection; and
storing, by the second node, the encrypted data into the storage device.

2. The computer-implemented method of claim 1, wherein the second node has a direct connection to the storage device.

3. The computer-implemented method of claim 1, further comprising:
verifying, by the second node, an integrity of the encrypted data using the integrity information; and
wherein storing, by the second node, the encrypted data in response to successfully verifying the integrity of the encrypted data.

4. The computer-implemented method of claim 1, further comprising:
loading, by the second node, the encrypted data from the storage device in response to a request for the encrypted data from the first node;
sending, by the second node and to the first node, the encrypted data via the unsecured network connection; and
sending, by the second node and to the first node, additional integrity information for the encrypted data via the authenticated encrypted network connection.

5. The computer-implemented method of claim 4, further comprising decrypting, by the first node, the encrypted data.

6. The computer-implemented method of claim 5, further comprising:
verifying, by the first node, an integrity of the encrypted data using the additional integrity information; and
wherein decrypting the encrypted data is performed in response to successfully verifying the integrity of the encrypted data.

7. The computer-implemented method of claim 1, wherein the authenticated encrypted network connection comprises an authenticated encrypted transport layer security (TLS) network connection.

8. The computer-implemented method of claim 1, wherein the data is encrypted by the first node using a symmetric key encryption scheme.

9. A computer system comprising:
a processor set;
one or more computer readable storage media; and
program instructions stored on the one or more storage media to cause the processor set to perform operations comprising:
encrypting, by a first node of a distributed file system, data to be stored in a storage device of the distributed file system;
sending, by the first node to a second node of the distributed file system, the encrypted data using an unsecured network connection;
sending, by the first node and to the second node of the distributed file system, integrity information for the encrypted data using an authenticated encrypted network connection; and
storing, by the second node, the encrypted data into the storage device.

10. The computer system of claim 9, wherein the second node has a direct connection to the storage device.

11. The computer system of claim 9, wherein the operations further comprise:
verifying, by the second node, an integrity of the encrypted data using the integrity information; and
wherein storing, by the second node, the encrypted data in response to successfully verifying the integrity of the encrypted data.

12. The computer system of claim 9, wherein the operations further comprise:
loading, by the second node, the encrypted data from the storage device in response to a request for the encrypted data from the first node;
sending, by the second node and to the first node, the encrypted data via the unsecured network connection; and
sending, by the second node and to the first node, additional integrity information for the encrypted data via the authenticated encrypted network connection.

13. The computer system of claim 12, wherein the operations further comprise decrypting, by the first node, the encrypted data.

14. The computer system of claim 13, wherein the operations further comprise:
verifying, by the first node, an integrity of the encrypted data using the additional integrity information; and
wherein decrypting the encrypted data is performed in response to successfully verifying the integrity of the encrypted data.

15. The computer system of claim 9, wherein the authenticated encrypted network connection comprises an authenticated encrypted transport layer security (TLS) network connection.

16. The computer system of claim 9, wherein the data is encrypted by the first node using a symmetric key encryption scheme.

17. A computer program product comprising:
one or more computer readable storage media; and
program instructions stored on the one or more storage media to perform operations comprising:
encrypting, by a first node of a distributed file system, data to be stored in a storage device of the distributed file system;
sending, by the first node to a second node of the distributed file system, the encrypted data using an unsecured network connection;
sending, by the first node and to the second node of the distributed file system, integrity information for the encrypted data using an authenticated encrypted network connection; and
storing, by the second node, the encrypted data into the storage device.

18. The computer program product of claim 17, wherein the second node has a direct connection to the storage device.

19. The computer program product of claim 17, wherein the operations further comprise:
verifying, by the second node, an integrity of the encrypted data using the integrity information; and
wherein storing, by the second node, the encrypted data in response to successfully verifying the integrity of the encrypted data.

20. The computer program product of claim 17, wherein the operations further comprise:
loading, by the second node, the encrypted data from the storage device in response to a request for the encrypted data from the first node;
sending, by the second node and to the first node, the encrypted data via the unsecured network connection; and
sending, by the second node and to the first node, additional integrity information for the encrypted data via the authenticated encrypted network connection.
